(19) United States
(12) Patent Application Publication
(10) Pub. No.: US 2026/0255161 A1
(43) Pub. Date: Aug. 27, 2026

(54) A METHOD AND APPARATUS FOR UPDATING CREDENTIAL INFORMATION IN A WIRELESS COMMUNICATION SYSTEM

(71) Applicant: Samsung Electronics Co., Ltd., Gyeonggi-do (KR)

(72) Inventors: Naman GUPTA, Gyeonggi-do (KR); Kisuk KWEON, Gyeonggi-do (KR)

(21) Appl. No.: 18/995,443

(22) PCT Filed: Aug. 1, 2023
(86) PCT No.: PCT/KR2023/011231

§ 371 Date: Jan. 16, 2025

(30) Foreign Application Priority Data
Aug. 3, 2022 (KR) 10-2022-0096627

(51) Int. Cl. H04W 12/06; H04L 9/40; H04W 60/04

(52) U.S. Cl. CPC H04W 12/06; H04L 63/0892; H04W 60/04

(57) ABSTRACT

The disclosure relates to a 5G or 6G communication system for supporting a higher data transmission rate. A method and apparatus for updating credential information in a wireless communication system is provided. According to an embodiment of the disclosure, a method of a user equipment (UE) in wireless communication system includes: transmitting, to an access and mobility function (AMF) entity, a registration request message based on a credential of a credentials holder via 3rd generation partnership project (3GPP) interworking function (N3IWF) entity for an untrusted non-3GPP access, and receiving, from the AMF entity, a registration accept message including updated credential information or a credential information update indication. The updated credential information included in the registration message includes at least one of: credentials holder controlled prioritized list of preferred standalone non-public networks (SNPNs) with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

### TECHNICAL FIELD

The disclosure relates to a method and apparatus for updating credential information in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

Provided are a method and apparatus for updating credential information in a wireless communication system.

Additional aspects will be set forth in part in the description which follows and, in part, will be apparent from the description, or may be learned by practice of the presented embodiments of the disclosure.

According to an embodiment of the disclosure, a method of a user equipment (UE) in wireless communication system includes: transmitting, to an access and mobility function (AMF) entity, a registration request message based on a credential of a credentials holder via 3rd generation partnership project (3GPP) interworking function (N3IWF) entity for an untrusted non-3GPP access, and receiving, from the AMF entity, a registration accept message including updated credential information or a credential information update indication. The updated credential information included in the registration message includes at least one of: credentials holder controlled prioritized list of preferred stand-alone non-public networks (SNPNs) with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

### Advantageous Effects of Invention

According to the various embodiments of the disclosure, a method and apparatus for updating credential information in a wireless communication system is provided.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an example of UE connecting to N3IWF via Untrusted Non-3GPP access according to various embodiments of the disclosure;

FIG. 2 is a diagram illustrating Non-roaming architecture for 5G Core Network with untrusted non-3GPP access;

FIG. 3 is a diagram illustrating 5G System architecture with access to SNPN using credentials from Credentials Holder using AUSF and UDM;

FIG. 4 is a diagram illustrating 5G System architecture with access to SNPN using credentials from Credentials Holder using AAA Server;

FIG. 5 is a diagram illustrating an example of UE connecting to SNPNs based on GIN using credentials of a Credentials Holder;

FIG. 6 is a flow chart of provisioning credential information during UE Onboarding procedure according to an embodiment of the disclosure;

FIG. 7 is a flow chart of updating credential information when the Credentials Holder includes AUSF and UDM according to an embodiment of the disclosure;

FIG. 8 is a flow chart of updating credential information when the Credentials Holder includes AAA server according to an embodiment of the disclosure;

FIG. 9 is a flow chart of updating credential information when the Credentials Holder includes AAA server according to another embodiment of the disclosure;

FIG. 10 is a block diagram of a configuration of a UE according to an embodiment of the present disclosure;

FIG. 11 is a block diagram of a configuration of a network entity according to an embodiment of the present disclosure;

### BEST MODE FOR CARRYING OUT THE INVENTION

The present disclosure relates to wireless communication systems and, more specifically, the present disclosure relates to a method and apparatus for updating credential information in a wireless communication system.

According to an embodiment of the disclosure, a method of a user equipment (UE) in wireless communication system includes: transmitting, to an access and mobility function (AMF) entity, a registration request message based on a credential of a credentials holder via 3rd generation partnership project (3GPP) interworking function (N3IWF) entity for an untrusted non-3GPP access, and receiving, from the AMF entity, a registration accept message including updated credential information or a credential information update indication. The updated credential information included in the registration message includes at least one of: credentials holder controlled prioritized list of preferred stand-alone non-public networks (SNPNs) with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

According to an embodiment of the disclosure, a method of an access and mobility function (AMF) entity in wireless communication system includes: receiving, from a user equipment (UE), a registration request message based on a credential of a credentials holder via 3rd generation partnership project (3GPP) interworking function (N3IWF) entity for an untrusted non-3GPP access, receiving, from the credentials holder, updated credential information or a credential information update indication, and transmitting, to the UE, a registration accept message including the updated credential information or the credential information update indication. The updated credential information includes at least one of: credentials holder controlled prioritized list of preferred stand-alone non-public network (SNPN) s with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

According to an embodiment of the disclosure, a user equipment (UE) in wireless communication system includes: a transceiver, and a controller operably coupled to the transceiver, the controller configured to: transmit, to an access and mobility function (AMF) entity, a registration request message based on a credential of a credentials holder via 3rd generation partnership project (3GPP) interworking function (N3IWF) entity for an untrusted non-3GPP access, and receive, from the AMF entity, a registration accept message including updated credential information or a credential information update indication. The updated credential information included in the registration message includes at least one of: credentials holder controlled prioritized list of preferred stand-alone non-public networks (SNPNs) with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

According to an embodiment of the disclosure, an access and mobility function (AMF) entity in wireless communication system includes: a transceiver, and a controller operably coupled to the transceiver, the controller configured to: receive, from a user equipment (UE), a registration request message based on a credential of a credentials holder via 3rd generation partnership project (3GPP) interworking function (N3IWF) entity for an untrusted non-3GPP access, receive, from the credentials holder, updated credential information or a credential information update indication, and transmit, to the UE, a registration accept message including the updated credential information or the credential information update indication. The updated credential information includes at least one of: credentials holder controlled prioritized list of preferred stand-alone non-public network (SNPN) s with N3IWF fully qualified domain names (FQDNs) of the preferred SNPNs, credentials holder controlled prioritized list of group identifier (ID) for network selections (GINs) with N3IWF FQDNs of SNPNs which broadcast the GINs, or credentials holder controlled prioritized list of N3IWFs.

### MODE FOR THE INVENTION

Technical features may be readily apparent to one skilled in the art from the following figures, descriptions, and claims.

Before undertaking the description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

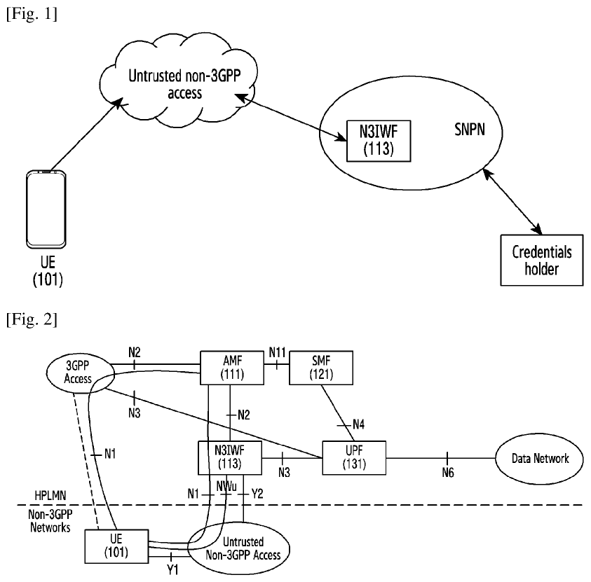

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Herein, terms to identify access nodes, terms to refer to network entities or network functions (NFs), terms to refer to messages, terms to refer to interfaces between network entities, terms to refer to various types of identification information, etc., are examples for convenience of explanation. Therefore, the disclosure is not limited to the terms to be described later, and other terms referring to entities having an equivalent technical meaning may be used.

For convenience of explanation, the disclosure will hereinafter use terms and definitions defined by the 3GPP LTE and 5G standards. However, the disclosure is not limited by the terms and names and may be equally applied to systems conforming to other standards.

Entities that exchange information for access control and status management will now be collectively called “NFs” for convenience of explanation. For example, the NF may be at least one of an access and mobility management function (hereinafter referred to as an AMF) apparatus, a session management function (hereinafter referred to as an SMF) apparatus, or a network slice selection function (hereinafter referred to as an NSSF) apparatus. Embodiments of the disclosure may, however, be equally applied to an occasion when the NF is implemented as an instance, e.g., an AMF instance, an SMF instance, an NSSF instance, etc.

In the disclosure, in an instance, an NF may be present in the form of a software code, and may be executable by receiving physical and/or logical resources from a physical computing system, for example, a computing system present on a core network, to perform a function of the NF in the computing system. All NF instances, such as an AMF instance, an SMF instance, or the like, may refer to instances that may be used by receiving physical and/or logical resources for an NF operation from a computing system present on a core network. As a result, an NF instance in a case where a physical NF apparatus, such as an AMF, SMF, or the like, is present and an NF instance that receives and uses physical and/or logical resources for an NF operation from a computing system present on a network may perform the same operation.

FIG. 1 is a diagram illustrating an example of UE connecting to N3IWF via Untrusted Non-3GPP access according to various embodiments of the disclosure, and FIG. 2 is a diagram illustrating Non-roaming architecture for 5G Core Network with untrusted non-3GPP access.

Referring to FIG. 1, UE 101 accesses to Stand-Alone Non-Public Network (SNPN) via non-3GPP Interworking Function (N3IWF) 113 for untrusted non-3GPP access. SNPN may authenticate the UE 101 by using credentials owned by credentials holder which is separate from the SNPN.

Non-public networks (NPNs) enable to deploy and use a 5G system for private use. It allows creating a dedicated network with optimized services within a particular area. They are intended for exclusive use of an enterprise customer. NPNs or Private networks are expected to fuel industrial and business transformation by being important enablers in Industry 4.0.

5G systems are designed to enable access not just via 5G radio access network (RAN) nodes (eNodeBs) but also through other access networks like Wifi (802.11), wireless local-area network (WLAN) etc. These other accesses are referred to as non3GPP accesses. Adding the support for non-3GPP access in Non-Public Networks is crucial for vertical domains like smart factories, airport/railway hubs, remote sites (such as mines, oil platforms etc.) Support of non-3GPP access provides non-5G RAN such as public Wifi to connect to 5G Core Network via a common interface.

Stand-Alone Non-Public Network (SNPN) is a NPN having dedicated 5G core entities and operate as a separate network as contrast to PNI-NPN (Public Network Integrated-NPN) which uses public land mobile network (PLMN) core. In addition to the regular authentication as done in PLMN, SNPN also allows UE to be authenticated using credentials owned by credentials holder that are separate from the SNPNs.

Credentials holder can be thought of as the primary provider of UE's subscription. It may be possible that credentials holder or more specifically the entity, which provided UE with the SNPN credentials, have agreement with many different SNPNs for providing services to its UEs. So, different SNPNs can support authentication via a particular credentials holder.

Untrusted networks include WLANS like public hotspots, home Wi-Fi, corporate Wi-Fi etc. that are not in the scope of network operators. They are called untrusted because of the fact that mobile network operator does not trust in the security offered by these Non-3GPP access networks. In order to have an interworking of Untrusted non-3GPP networks and the 5G Core Network, the non-3GPP Interworking Function (N3IWF) 113 is used.

As illustrated in FIG. 2, UE 101 may access to 5G Core Network via different connection path for 3GPP Access and Untrusted Non-3GPP Access. UE 101 may directly access to 5G Core Network for 3GPP Access. However, UE 101 should access to 5G Core Network via N3IWF 113 for Untrusted Non-3GPP Access.

The 5G System Architecture contains the following reference points:
N1: Reference point between the UE 101 and the AMF 111.
N2: Reference point between the (R) AN and the AMF 111.
N3: Reference point between the (R) AN and the UPF 131.
N4: Reference point between the SMF 121 and the UPF 131.
N6: Reference point between the UPF 131 and a Data Network.
N11: Reference point between the AMF 111 and the SMF 121.
Y1: Reference point between the UE 101 and the untrusted non-3GPP access (e.g. WLAN). This depends on the non-3GPP access technology and is outside the scope of 3GPP.
Y2: Reference point between the untrusted non-3GPP access and the N3IWF 113 for the transport of NWu traffic.
NWu: Reference point between the UE 101 and N3IWF 113 for establishing secure tunnel(s) between the UE 101 and N3IWF 113 so that control-plane and user-plane exchanged between the UE 101 and the 5G Core Network is transferred securely over untrusted non-3GPP access.

N3IWF 113 acts as a gateway for the 5G Core Network with support for N2 and N3 interface towards the 5G Core Network. Additionally, N3IWF 113 may provide a secure connection for the UE accessing the 5G Core Network over non-3GPP access network with support for IPsec between the UE 101 and the N3IWF 113. Thus, N3IWF 113 mainly provides a secure gateway to 5G Core Network for non-3GPP access.

When UE 101 decides to use untrusted non-3GPP access to connect to a 5G Core Network in a PLMN, UE 101 first selects and connects with a non-3GPP access network. Then, UE 101 selects a PLMN/SNPN and an N3IWF 113 in this PLMN/SNPN. The PLMN/SNPN/N3IWF selection and the non-3GPP access network selection are independent.

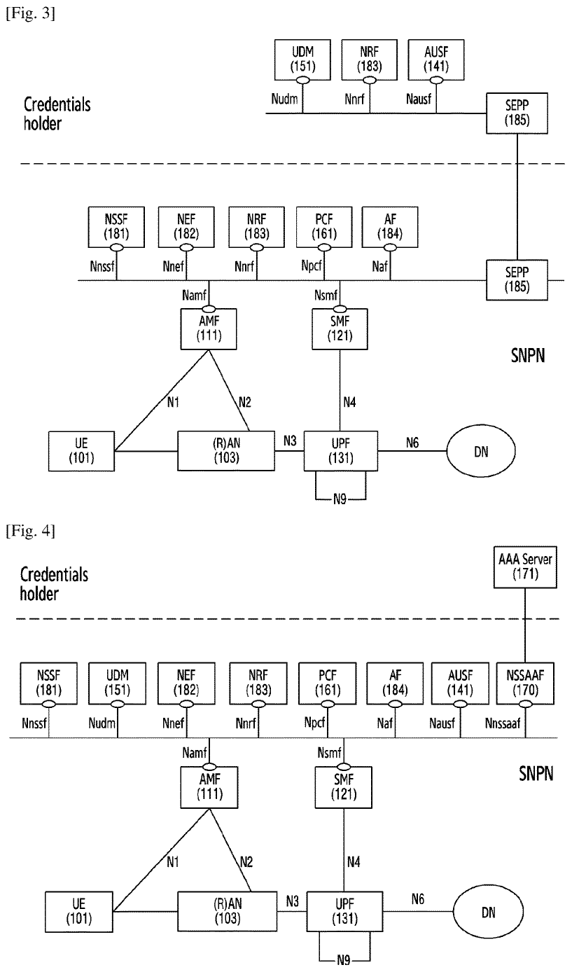

FIG. 3 is a diagram illustrating 5G System architecture with access to SNPN using credentials from Credentials Holder using AUSF and UDM, and FIG. 4 is a diagram illustrating 5G System architecture with access to SNPN using credentials from Credentials Holder using AAA Server.

Referring to FIG. 3 and FIG. 4, a radio access node (RAN) 103 and a user equipment (UE) 101 are shown as a part of nodes using a radio channel in a wireless communication system. Although there is one RAN 103 and one UE 101 shown in FIG. 3 and FIG. 4, another RAN, which is identical or similar to the RAN 103, may be further included. Furthermore, FIG. 3 and FIG. 4 are focused on an occasion when the single UE 101 performs communication with the single RAN 103. It is, however, obvious that there may be actually a plurality of UEs communicating with the single RAN 103.

The RAN 103 includes a network infrastructure that provides a radio access to the UE 101. The RAN 103 may have a coverage defined to be a certain geographic area based on a range within which a signal may be transmitted from the RAN 103. In addition to a base station, the RAN 103 may be referred to as an access point (AP), an eNodeB (eNB), a gNodeB (gNB), a 5th generation (5G) node, a wireless point, a transmission/reception point (TRP), or other terms having an equivalent technical meaning.

The AMF 111 may include a network entity for managing wireless network access and mobility. The SMF 121 may include a network entity that manages access of a packet data network for providing packet data to the UE 101. The UE 101 and the SMF 121 may be connected to each other through a packet data unit (PDU) session.

A user plane function (UPF) 131 may include a gateway that delivers packets transmitted and received by the UE 101, or may serve as the gateway. The UPF 131 may be connected to a data network (DN) via the Internet to provide a path between the UE 101 and the DN for data transmission or reception. Accordingly, the UPF 131 may route data to be delivered to the Internet from among the packets transmitted by the UE 101 to an Internet data network.

A network slice selection function (NSSF) 181 may include a network entity that performs a network selection operation described herein, for example, an operation of selecting a network slice.

An authentication server function (AUSF) 141 may provide a service for a subscriber authentication process.

A unified data management (UDM) 151 may store information about a subscriber and/or the UE 101.

A policy and charging function (PCF) 161 may apply a service policy of a mobile network operator, a charging policy, and a policy for a PDU session for the UE 101.

A network exposure function (NEF) 182 may access information for managing the UE 120 in the 5G network, subscribe to a mobility management event of the UE 120, subscribe to a session management event of the UE 120, request session-related information, set charging information of the UE 120, request a change in PDU session policy for the UE 120, and transmit a small amount of data for the UE 120.

A network slice-specific and SNPN authentication and authorization function (NSSAAF) 170 may support for network slice-specific authentication and authorization a authentication, authorization and accounting (AAA) server 171. If AAA server 171 belongs to a third party, the NSSAAF 170 may contact the AAA sever 171 via a AAA proxy. Further, The NSSAAF 170 may support for access to SNPN using credentials from Credentials Holder using AAA server 171 or using credentials from default credentials server using AAA server 171. If the credentials holder or default credentials server belongs to a third party, the NSSAAF 170 may contact the AAA server 171 via a AAA proxy. When the NSSAAF 170 is deployed in a SNPN, the NSSAAF 170 can support network slice-specific authentication and authorization and/or the NSSAAF 170 can support access to SNPN using credentials from credentials holder.

An authentication, authorization and accounting (AAA) server 171 provides the Authentication, Authorisation, Accounting (AAA) functionality to allow non-3GPP access, such as Wi-Fi, to the operator's EPC (Evolved Packet Core). Thus, it makes possible to use non-3GPP connections, both trusted and untrusted, for services that require user authentication. In a roaming situation, the 3GPP AAA Server also acts as a proxy server.

A network repository function (NRF) 183 may store status information of NFs and process requests for finding NFs that may be accessed by other NFs.

An application function (AF) 184 may provide a service to users by interworking with a mobile communication network.

A security edge protection proxy (SEPP) 185 is a non-transparent proxy and supports message filtering and policing on inter-PLMN control plane interfaces. The SEPP 185 protects the connection between service consumers and service producers from a security perspective, i.e. the SEPP 185 does not duplicate the service authorization applied by the service producers.

Referring to FIG. 3, SNPN may support primary authentication and authorization of UEs that use credentials from a credentials holder using AUSF 141 and UDM 151. The credentials holder may be an SNPN or a PLMN. The credentials holder UDM 151 provides to SNPN the subscription data. A SNPN may support network slicing (including network slice-specific authentication and authorization (NSSAA), network slice access control and subscription-based restrictions to simultaneous registration of network slices (NSSRG)) for UEs that use credentials from a credentials holder using AUSF 141 and UDM 151. The SNPN retrieves NSSAA and NSSRG information from the UDM 151 of the credentials holder.

Referring to FIG. 4, the AUSF 141 and the UDM 262 in SNPN may support primary authentication and authorization of UEs using credentials from a AAA Server 171 in a credentials holder. Only network slice instance (NSI) based subscription permanent identifier (SUPI) is supported and the SUPI is used to identify the UE during primary authentication and authorization towards the AAA Server 171. The AMF 111 discovers and selects the AUSF 141 using the home network identifier (realm part) and routing indicator present in the subscription concealed identifier (SUCI) provided by a UE 101. The AMF 111 selects the UDM 151 in the same SNPN, based on local configuration (e.g. using the realm part of the SUCI), or using the NRF procedure.

If the UDM 151 decides that the primary authentication is performed by AAA Server 171 in credentials holder based on the UE 101's SUPI and subscription data. The home network identifier, is derived by UDM 151 from the SUCI received from AUSF 141. If the SUCI was generated using a privacy protection scheme that requires deconcealment, UDM 151 de-conceal the SUCI. The UDM 151 then instructs the AUSF 141 that primary authentication by a AAA Server 171 in a credentials holder is required, the AUSF 141 shall discover and select the NSSAAF 170, and then forward extensible authentication protocol (EAP) messages to the NSSAAF 170. The NSSAAF 170 selects AAA Server 171 based on the domain name corresponds to the realm part of the SUPI, relays EAP messages between AUSF 141 and AAA Server 171 (or AAA proxy) and performs related protocol conversion. The AAA Server 171 acts as the EAP Server for the purpose of primary authentication.

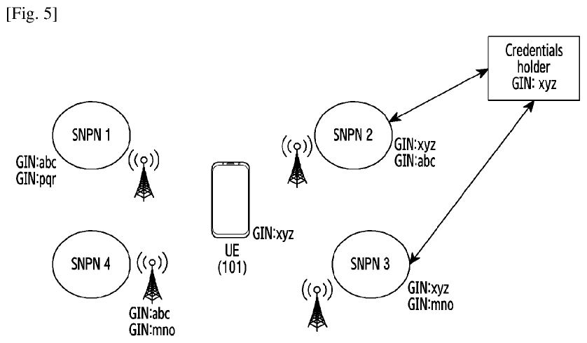

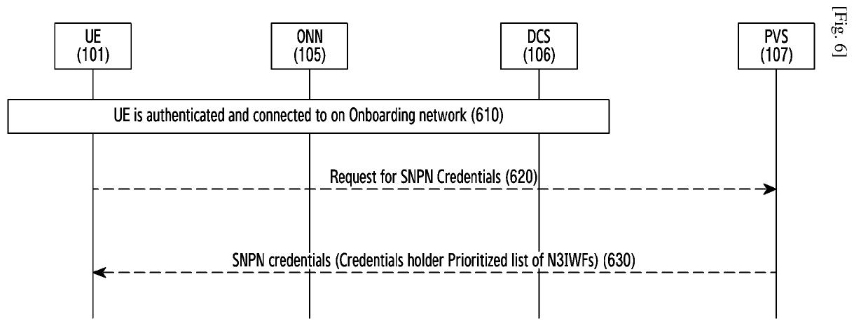

FIG. 5 is a diagram illustrating an example of UE connecting to SNPNs based on GIN using credentials of a Credentials Holder;

The entity which provided subscription or credentials for an SNPN may have dynamic arrangements with different network operators for its user to use services of the particular SNPNs owned by that network operator. Note that there might not exist a physical network corresponding to an SNPN id. The subscribers or credential holders for that SNPN ID may connect to other SNPNs based on broadcasted information from the RAN cells and the configured data in the User Equipment.

Group ID for Network Selection (GIN) is an identifier used to enhance the likelihood of selecting a preferred SNPN that supports a particular credentials holder. GINs are broadcasted by the cells for a particular SNPN, and UE choose to select that particular PLMN which broadcasts the GIN configured in the UE credentials. Thus, Credential Holder can just store the GIN info in the UE, and the SNPN which have agreement with the Credential Holder will broadcast the particular GIN, when the agreement ends, it will stop broadcasting the particular GIN.

Referring to FIG. 5, each of SNPN 1, SNPN 2, SNPN 3, SNPN 4 broadcast particular GIN associated with a particular credentials holders. Also, UE 101 is configured with the prioritized list of GIN by the credentials holder. In FIG. 5, SNPN 1 broadcasts GINs abc and pqr, SNPN 2 broadcasts GINs xyz and abc, SNPN 3 broadcasts GINs abc and mno, SNPN 4 broadcasts GINs xyz and mno. Credentials holder is indicated with GIN: xyz and UE 101 is configured with GIN: xyz. Thus, UE 101 may access to SNPN 2 and SNPN 4 which supports the credentials holder.

In the case for connection via NG-RAN, it is easier for the UE 101 to perform SNPN selection because of the broadcasted information (e.g., GIN) from the cells. But, for the case of untrusted Non-3GPP access, UE 101 must be configured with the N3IWF information so as to connect to the 5G Core Network which provides authentication via credential holder of the UE 101.

In the case of untrusted Non-3GPP access in the PLMN scenario, there is an actual physical network for that PLMN and UE 101 is configured with FQDN of the N3IWF so as to connect via Untrusted Non 3GPP access. But, when we take the case of SNPN credential holder scenarios, particularly when UE 101 is configured with prioritized list of GINS, a particular GIN may be broadcasted by a large number of SNPNs, that is large number of SNPNs may support a particular GIN. Since the untrusted Non-3GPP access point do not broadcast SNPN related information, UE 101 itself need to know the address of N3IWF in a particular SNPN which supports credentials from the UE 101's credential holder.

An embodiment of the present disclosure provides a method and apparatus for the connection of UE 101 via Untrusted Non-3GPP access in the credentials holder scenarios. In addition, because of the dynamic nature of business relationships, list of SNPNs that serve a GIN can be continuously changing. Thus, UE 101 need to be updated regarding the N3IWF information by the credential holder.

There are two type of credentials holder that can be used in the SNPN scenario.
1) Credentials holder is UDM 151/AUSF 141 as illustrated in FIG. 3.
2) Credentials holder is AAA server 171 as illustrated in FIG. 4.

AAA server 171 is essential for security, provisioning and billing. In context of private networks, it will greatly help in Internet of Things (IoT) eco system. Businesses will have agreement with operators for providing its users access to service to their networks while maintaining their AAA server 171 for the purpose of authorization and billing. This can greatly help in supporting dynamic business relationships that involve complex resource sharing and roaming partnerships

Note that as different from the PLMN scenario, the entity managing AAA server 171 (as credentials holder) may not have a physical network and thus cannot configure a single, fixed N3IWF FQDN in the UE 101. The credentials holder (AAA server 171) will need to update UE 101 with the N3IWF information.

In addition, some DNS based procedure are used to find N3IWF 113 in the PLMN case. Doing such kind of procedures by utilizing GIN by forming FQDN that incorporates GIN, leads to issues like which entity will handle and responsible for the DNS based queries for a GIN.

In a scenario where UE 101 has credentials for SNPN provided by a particular credentials holder. There can be multiple SNPNs which supports connectivity for a UE 101 via the particular SNPN. Now to connect to this network via Untrusted Non-3GPP access, UE 101 need to have N3IWF information of one such particular SNPN that supports connectivity via the particular credentials holder.

According to an embodiment of the present disclosure, credential information including the N3IWF information may be configured as following [Table 1] or [Table 2].

TABLE 1
Information

| | |
|---|---|
| PLMN ID and NID of the subscribed SNPN | |
| Subscription identifier (SUPI) and credentials for the subscribed | |
| SNPN | |
| Optionally, an N3IWF FQDN and an identifier of the country | |
| where the configured N3IWF is located | |
| User controlled prioritized list of preferred SNPNs; | Optionally, if the UE |
| Credentials Holder controlled prioritized list of preferred SNPNs, | supports access to an |
| optionally an N3IWF FQDN of that SNPN | SNPN using credentials |
| Credentials Holder controlled prioritized list of GINs; optionally | from a credentials |
| N3IWF FQDNs of those SNPNs which broadcast this GIN | holder |

TABLE 2
Information

| | |
|---|---|
| PLMN ID and NID of the subscribed SNPN | |
| Subscription identifier (SUPI) and credentials for the subscribed | |
| SNPN | |
| Optionally, an N3IWF FQDN and an identifier of the country | |
| where the configured N3IWF is located | |
| User controlled prioritized list of preferred SNPNs; | Optionally, if the UE |
| Credentials Holder controlled prioritized list of preferred SNPNs, | supports access to an |
| Credentials Holder controlled prioritized list of GINs | SNPN using credentials |
| | from a credentials |
| | holder |

Reason why we are including multiple N3IWF IDs is that UE 101 by the virtue of its credential holder may be served by many SNPNs and a particular SNPN might not be reachable via the Non-3GPP access point to which the UE is connected to. This is because it may be possible that Non-3GPP access point does not provide internet connectivity to UE 101, and is only within a local area network (LAN). In this case, UE 101 will re-attempt to connect that particular SNPN's N3IWF which may be reachable from UE 101 (that is it may be within that LAN).

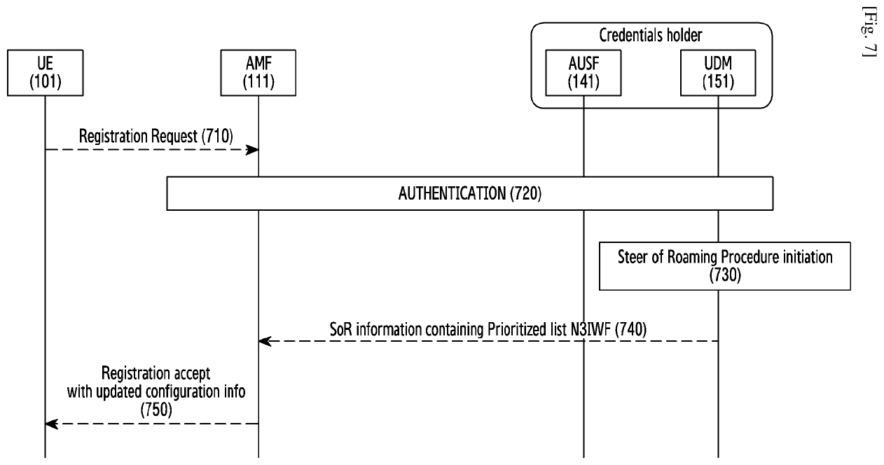

FIG. 6 is a flow chart of provisioning credential information during UE Onboarding procedure according to an embodiment of the disclosure.

In operation 610, UE 101 may access to an onboarding network (ONN) 105 and may performs authentication based on the default UE credentials with default credentials server (DCS) 106. It is possible for the DCS 106 to provide means for another entity to perform authentication based on the default UE credentials.

In operation 620, UE 101 may transmit a request message requesting at least one SNPN credential to a provisioning server (PVS) 107. PVS 107 may provision network credentials and other data in the UE 101 to enable SNPN access.

In operation 630, PVS 107 may transmit credential information to the UE 101. In an embodiment, the credential information includes SNPN credentials including credentials holder prioritized list of N3IWFs. Further, the credential information includes at least one of: credentials holder controlled prioritized list of preferred SNPNs with N3IWF FQDNs of the preferred SNPNs, credentials holder controlled prioritized list of GINs with N3IWF FQDNs of SNPNs which broadcast the GINs, or credentials holder controlled prioritized list of N3IWFs.

As described above, credentials holder may provide UE 101 multiple SNPN IDs or GINs (which are broadcasted by SNPN cells) which UE 101 can select to avail SNPN services. These SNPNs can authenticate and authorize UE 101's credentials by contacting the particular credential holder.

For reasons like change in business agreement of credential holder (the entity which provided UE the subscription) with a particular SNPN, that SNPN can stop providing services to the UE 101. The cells may stop broadcasting the UE configured GIN for that SNPN, and hence UE 101 will not select that SNPN during SNPN selection procedure. But in the scenario for Untrusted Non-3GPP access, if the credentials holder controlled list may contain N3IWF 113 of an SNPN which no longer provides services for the UEs for the particular credential holder, UE 101 must need to update the configuration information regarding the prioritized list of N3IWFs.

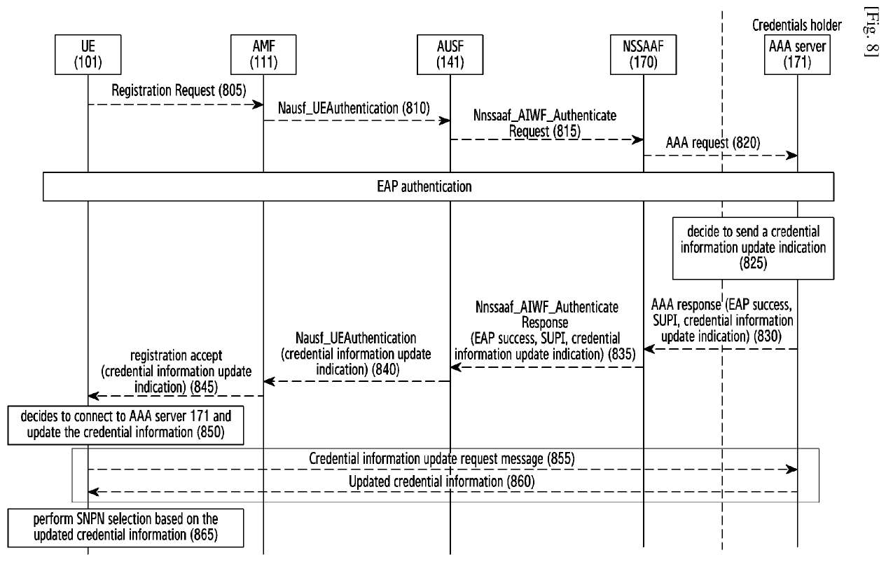

FIG. 7 is a flow chart of updating credential information when the Credentials Holder includes AUSF and UDM according to an embodiment of the disclosure.

In operation 710, UE 101 may transmit a registration request message based on a credential of a credentials holder via N3IWF 113 for an untrusted non-3GPP access to the AMF 111. In an embodiment, the credentials holder may include AUSF 141 and UDM 151.

In operation 720, AMF 111 may perform authentication procedure with AUSF 141 and UDM 151 which are included in the credentials holder.

In operation 730, UDM 151 performs steering of roaming (SoR) procedure. In an embodiment, SoR procedure is used to update credential information. Specifically, UDM 151 may include updated credential information in the SoR information during the SoR procedure.

In operation 740, UDM 151 may transmit SoR information including the updated credential information to the AMF 111. In an embodiment, the updated credential information includes at least one of: credentials holder controlled prioritized list of preferred SNPNs with N3IWF FQDNs of the preferred SNPNs, credentials holder controlled prioritized list of GINs with N3IWF FQDNs of SNPNs which broadcast the GINs, or credentials holder controlled prioritized list of N3IWFs.

In operation 750, AMF 111 may transmit a registration accept message including the updated credential information to the UE 101. In an embodiment, the UE 101 may perform SNPN selection based on the updated credential information.

The SoR procedure cannot be used when credential holder is AAA server 171. As the AAA server 171 is important for vertical industries, it is important to have a procedure that can update the credential information (i.e., UE configuration information) when credential holder is AAA server 171.

FIG. 8 is a flow chart of updating credential information when the Credentials Holder includes AAA server according to an embodiment of the disclosure.

Referring to FIG. 8, a credential information update indication is provided to the UE 101 with a registration accept message.

In operation 805, UE 101 may transmit a registration request message based on a credential of a credentials holder via N3IWF 113 for an untrusted non-3GPP access to the AMF 111. In an embodiment, the credentials holder may include is AAA server 171.

In operation 810, AMF 111 may transmit a Nausf_UEAuthentication message requesting authentication of the UE 101 to AUSF 141.

In operation 815, AUSF 141 may transmit a Nnssaaf_AIWF_Authenticate Request message with SUPI of the UE 101 to NSSAAF 170.

In operation 820, NSSAAF 170 may transmit AAA request message to AAA server 171. Then, extensible authentication protocol (EAP) authentication is performed between the UE 101 and the AAA server 171. The AAA Server 171 may act as the EAP Server for the purpose of primary authentication.

In operation 825, AAA server 171 may decide to send a credential information update indication. Specifically, AAA server 171 may perform user authentication. If AAA server 171 finds that UE configured information (e.g. credentials holder controlled lists) need to be updated AAA server 171 decides to send additional indication for UE to trigger updating stored information. The indication indicate to trigger an update procedure.

In operation 830, The AAA Server 171 may transmit AAA response message including information on EAP success, SUPI and credential information update indication to the NSSAAF 170.

In operation 835, NSSAAF 170 may transmit Nnssaaf_AIWF_Authenticate Response message including information on EAP success, SUPI, credential information update indication to the AUSF 141.

In operation 840, AUSF 141 may transmit Nausf_UEAuthentication message including a credential information update indication to the AMF 111.

In operation 845, AMF 111 may transmit a registration accept message including a credential information update indication to the UE 101.

In operation 850, UE 101 decides to connect to AAA server 171 and update the credential information.

In operation 855, UE 101 may transmit a credential information update request message to the AAA server 117.

In operation 860, AAA server 117 may transmit updated credential information to the UE 101. In an embodiment, the updated credential information includes at least one of: credentials holder controlled prioritized list of preferred SNPNs with N3IWF FQDNs of the preferred SNPNs, credentials holder controlled prioritized list of GINS with N3IWF FQDNs of SNPNs which broadcast the GINs, or credentials holder controlled prioritized list of N3IWFs.

In operation 865, UE 101 may perform SNPN selection based on the updated credential information.

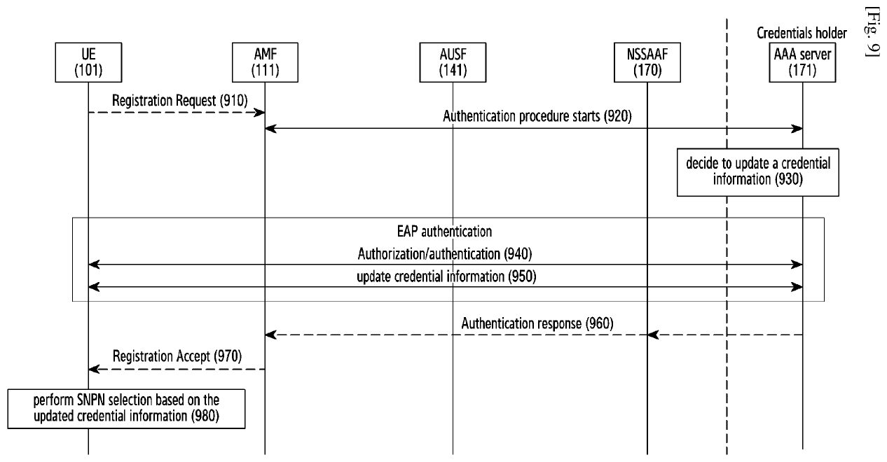

FIG. 9 is a flow chart of updating credential information when the Credentials Holder includes AAA server according to another embodiment of the disclosure.

Referring to FIG. 9, a credential information update indication is provided to the UE 101 in EAP authentication procedure.

In operation 910, UE 101 may transmit a registration request message based on a credential of a credentials holder via N3IWF 113 for an untrusted non-3GPP access to the AMF 111. In an embodiment, the credentials holder may include is AAA server 171.

In operation 920, AMF 111 starts authentication procedure with AUSF 141, NSSAAF 170 and AAA server 171.

In operation 930, AAA server 171 decide to update a credential information.

In operation 940, EAP authentication is performed between the UE 101 and the AAA server 171. The AAA Server 171 may act as the EAP Server for the purpose of primary authentication.

In operation 950, credential information update procedure is performed between the UE 101 and the AAA server 171. AAA server 171 may use EAP payload for credential information update procedure.

In operation 960, AAA server 171 may transmit authentication response to the AMF 111.

In operation 970, AMF 111 may transmit a registration accept message to the UE 101.

In operation 980, the UE 101 may perform SNPN selection based on the updated credential information.

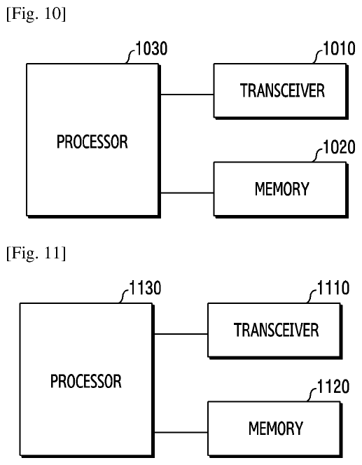

FIG. 10 is a block diagram of a configuration of a UE according to an embodiment of the present disclosure;

As shown in FIG. 10, the UE of the present disclosure may include a transceiver 1010, a memory 1020, and a processor 1030. The transceiver 1010, the memory 1020, and the processor 1030 of the terminal may operate according to a communication method of the terminal described above. However, the components of the terminal are not limited thereto. For example, the terminal may include more or fewer components than those described above. In addition, the processor 1030, the transceiver 1010, and the memory 1020 may be implemented as a single chip. Also, the processor 1030 may include at least one processor.

The transceiver 1010 collectively refers to a terminal receiver and a terminal transmitter, and may transmit or receive a signal to or from a base station. The signal transmitted or received to or from the base station may include control information and data. In this regard, the transceiver 1010 may include a RF transmitter for up-converting and amplifying a frequency of a transmitted signal, and a RF receiver for amplifying low-noise and down-converting a frequency of a received signal. However, it is merely an example of the transceiver 1010 and components of the transceiver 1010 are not limited to the RF transmitter and the RF receiver.

In addition, the transceiver 1010 may receive a signal on a wireless channel and output the signal to the processor 1030, or transmit a signal output from the processor 1030 through the wireless channel.

The memory 1020 may store a program and data required for operations of the terminal. Also, the memory 1020 may store control information or data included in a signal obtained by the terminal. The memory 1020 may include a storage medium such as a read only memory (ROM), a random access memory (RAM), a hard disk, a compact disc ROM (CD-ROM), and a digital versatile disc (DVD), or a combination of storage mediums.

The processor 1030 may control a series of processes such that the UE operates as described above. For example, the transceiver 1010 may receive a data signal including a control signal, and the processor 1030 may determine a result of receiving the data signal. In the disclosure, the processor 1030 may be referred to as a controller.

FIG. 11 is a block diagram of a configuration of a network entity according to an embodiment of the present disclosure;

As shown in FIG. 11, the network entity in the disclosure may include a transceiver 1110, a memory 1120, and a processor 1130. The processor 1130, the transceiver 1110, and the memory 1120 of the network entity may operate according to the aforementioned communication method of the network entity. Components of the network entity are not, however, limited thereto. For example, the network entity may include more or fewer elements than described above. In addition, the processor 1130, the transceiver 1110, and the memory 1120 may be implemented in the form of a chip. The processor 1130 may include at least one processor.

In an embodiment, the network entity may include the RAN 103, AMF 111, N3IWF 131, SMF 121, UPF 131, AUSF 141, UDM 151, PCF 161, NSSAAF 170, AAA server 171, NSSF 181, NEF 182, NRF 183, AF 184, and SEPP 185, etc., described with reference to FIG. 2 through FIG. 4. However, this is only an example, and the network entity may include various entities.

The transceiver 1110 is a collective term of a network entity receiver and a network entity transmitter, and may transmit or receive a signal to or from other network entities or UE. The signals transmitted to and received from the other network entities or UE may include control information and data. In this regard, the transceiver 1110 may include a RF transmitter for up-converting and amplifying a frequency of a transmitted signal, and a RF receiver for amplifying low-noise and down-converting a frequency of a received signal. It is merely an example of the transceiver 1110 and the components of the transceiver 1110 are not limited to the RF transmitter and RF receiver.

In addition, the transceiver 1110 may receive a signal on a wired/wireless channel and output the signal to the processor 1130, or transmit a signal output from the processor 1130 on a wired/wireless channel.

The memory 1120 may store a program and data required for an operation of the network entity. Furthermore, the memory 1120 may store control information or data included in a signal obtained by the network entity. The memory 1120 may include a storage medium such as a read only memory (ROM), a random access memory (RAM), a hard disk, a compact disc ROM (CD-ROM), and a digital versatile disc (DVD), or a combination of storage mediums.

The processor 1130 may control a series of processes for the network entity to be operated according to the embodiments of the disclosure. For example, the processor 1130 may receive a control signal and a data signal through the transceiver 1110, and process the received control signal and the received data signal. In addition, the processor 1130 may transmit the processed control signal and the processed data signal through the transceiver 1110. In the disclosure, the processor 1130 may be referred to as a controller.

According to the embodiments of the present disclosure, businesses providing SNPN subscriptions will be enabled, which the devices can connect to SNPN network using non-3GPP access (i.e., WiFi access) rather than 5G RAN. A large part of the IoT devices used in the Industry are enabled with non-3GPP access rather than 5G RAN equipment, the present disclosure will greatly help in supporting Industry 4.0 verticals.

In addition, the present disclosure provides a way to update credential information (i.e., UE configuration) when credentials holder is an AAA server 171. Thus allowing support for Untrusted Non-3GPP access in AAA server 171 credentials holder scenario, the present disclosure provides excellent opportunity for vendors to have dynamic relationships with different non-public network operators regarding the UEs which have credentials with that server

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

The above signaling flow diagrams illustrate example methods that can be implemented in accordance with the principles of the present disclosure and various changes could be made to the methods illustrated in the signaling flow diagrams herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method of a user equipment (UE) in wireless communication system, the method comprising:
transmitting, to an access and mobility function (AMF) entity, a registration request message based on a credential of a credentials holder via 3rd generation partnership project (3GPP) interworking function (N3IWF) entity for an untrusted non-3GPP access; and
receiving, from the AMF entity, a registration accept message including updated credential information or a credential information update indication,
wherein the updated credential information included in the registration message includes at least one of:
credentials holder controlled prioritized list of preferred stand-alone non-public networks (SNPNs) with N3IWF fully qualified domain names (FQDNs) of the preferred SNPNs,
credentials holder controlled prioritized list of group identifier (ID) for network selections (GINs) with N3IWF FQDNs of SNPNs which broadcast the GINs, or
credentials holder controlled prioritized list of N3IWFs.

2. The method of claim 1,
wherein the credentials holder includes authentication server function (AUSF) entity and unified data management (UDM) entity, and
wherein the registration accept message includes the updated credential information.

3. The method of claim 2, further comprising:
performing SNPN selection based on the updated credential information.

4. The method of claim 1,
wherein the credential holder includes authentication, authorization and accounting (AAA) server, and
wherein the registration accept message includes the credential information update indication.

5. The method of claim 4, further comprising:
transmitting, to the AAA server, a credential information update request message; and
receiving, from the AAA server, updated credential information, wherein the updated credential information received from the AAA server includes at least one of:
credentials holder controlled prioritized list of preferred SNPNs with N3IWF FQDNs of the preferred SNPNs,
credentials holder controlled prioritized list of GINs with N3IWF FQDNs of SNPNs which broadcast the GINs, or
credentials holder controlled prioritized list of N3IWFs.

6. The method of claim 5, further comprising:
performing SNPN selection based on the updated credential information.

7. The method of claim 1, further comprising:
accessing, to an onboarding network (ONN);
transmitting, to a provisioning server (PVS), a request message requesting at least one SNPN credential; and
receiving, from the PVS, credential information,
wherein the credential information includes at least one of:
credentials holder controlled prioritized list of preferred SNPNs with N3IWF FQDNs of the preferred SNPNs,
credentials holder controlled prioritized list of GINs with N3IWF FQDNs of SNPNs which broadcast the GINs, or
credentials holder controlled prioritized list of N3IWFs.

8. A method of an access and mobility function (AMF) entity in wireless communication system, the method comprising:
receiving, from a user equipment (UE), a registration request message based on a credential of a credentials holder via 3rd generation partnership project (3GPP) interworking function (N3IWF) entity for an untrusted non-3GPP access;
receiving, from the credentials holder, updated credential information or a credential information update indication; and
transmitting, to the UE, a registration accept message including the updated credential information or the credential information update indication,
wherein the updated credential information includes at least one of:
credentials holder controlled prioritized list of preferred stand-alone non-public network (SNPN) s with N3IWF fully qualified domain names (FQDNs) of the preferred SNPNs,
credentials holder controlled prioritized list of group identifier (ID) for network selections (GINs) with N3IWF FQDNs of SNPNs which broadcast the GINs, or
credentials holder controlled prioritized list of N3IWFs.

9. The method of claim 8,
wherein the credentials holder includes authentication server function (AUSF) entity and unified data management (UDM) entity, and wherein the receiving of the updated credential information or the credential information update indication comprises:
receiving, from the UDM, steering of roaming (SoR) information including the updated credential information in a SoR procedure.

10. The method of claim 8,
wherein the credential holder includes authentication, authorization and accounting (AAA) server, and
wherein the receiving of the updated credential information or the credential information update indication comprises:
receiving, from the AAA server, the credential information update indication.

11. A user equipment (UE) in wireless communication system, the UE comprising:
a transceiver; and
a controller operably coupled to the transceiver, the controller configured to:
transmit, to an access and mobility function (AMF) entity, a registration request message based on a credential of a credentials holder via 3rd generation partnership project (3GPP) interworking function (N3IWF) entity for an untrusted non-3GPP access, and
receive, from the AMF entity, a registration accept message including updated credential information or a credential information update indication,
wherein the updated credential information included in the registration message includes at least one of:
credentials holder controlled prioritized list of preferred stand-alone non-public networks (SNPNs) with N3IWF fully qualified domain names (FQDNs) of the preferred SNPNs,
credentials holder controlled prioritized list of group identifier (ID) for network selections (GINs) with N3IWF FQDNs of SNPNs which broadcast the GINs, or
credentials holder controlled prioritized list of N3IWFs.

12. The UE of claim 11,
wherein the credentials holder includes authentication server function (AUSF) entity and unified data management (UDM) entity, and
wherein the registration accept message includes the updated credential information.

13. The UE of claim 11,
wherein the credential holder includes authentication, authorization and accounting (AAA) server, and
wherein the registration accept message includes the credential information update indication.

14. The UE of claim 11, wherein the controller is further configured to:
transmit, to the AAA server, a credential information update request message, and
receive, from the AAA server, updated credential information, wherein the updated credential information received from the AAA server includes at least one of:
credentials holder controlled prioritized list of preferred SNPNs with N3IWF FQDNs of the preferred SNPNs,
credentials holder controlled prioritized list of GINs with N3IWF FQDNs of SNPNs which broadcast the GINs, or
credentials holder controlled prioritized list of N3IWFs.

15. An access and mobility function (AMF) entity in wireless communication system, the AMF entity comprising:
a transceiver; and
a controller operably coupled to the transceiver, the controller configured to:
receive, from a user equipment (UE), a registration request message based on a credential of a credentials holder via 3rd generation partnership project (3GPP) interworking function (N3IWF) entity for an untrusted non-3GPP access,
receive, from the credentials holder, updated credential information or a credential information update indication, and
transmit, to the UE, a registration accept message including the updated credential information or the credential information update indication, wherein the updated credential information includes at least one of:
credentials holder controlled prioritized list of preferred stand-alone non-public network (SNPN) s with N3IWF fully qualified domain names (FQDNs) of the preferred SNPNs,
credentials holder controlled prioritized list of group identifier (ID) for network selections (GINs) with N3IWF FQDNs of SNPNs which broadcast the GINs, or
credentials holder controlled prioritized list of N3IWFs.
